(19) United States
(12) Patent Application Publication
(10) Pub. No.: US 2006/0021342 A1
(43) Pub. Date: Feb. 2, 2006

(54) Hydraulic device in accordance with the features of the preamble of patent claim

(76) Inventor: Wilhelm Lupold, Vöhringen (DE)

Correspondence Address: NATH & ASSOCIATES, 1030 15th STREET, NW, 6TH FLOOR, WASHINGTON, DC, 20005, US

(21) Appl. No.: 11/193,612

(22) Filed: Aug. 1, 2005

(30) Foreign Application Priority Data
Aug. 2, 2004 (DE) 10 2004 037 697.2

(51) Int. Cl. F16D 31/02

(52) U.S. Cl. 60/477

(57) ABSTRACT

The invention relates to a hydraulic device (1), with a piston that moves inside a cylinder; a pump piston guided in a pump cylinder; a tank chamber for a hydraulic medium; and two valve units. The invention is based on the problem of proposing a functionally improved and more cost-effective hydraulic device (1). This problem is solved in that the piston (3), the pump cylinder (9), and the tank compartment (11, 12, 13, 14) are formed in each case by at least one compartment (3, 9, 11, 12, 13, 14) belonging to a profile tube (3).

This kind of hydraulic device is known from DE 43 40 236 A1. The hydraulic device described there is intended particularly for a chair with a pedal-operated seat-height adjustment capability, as might be employed, e.g., in a barber's chair. The hydraulic device consists of a lifting unit, with lifting cylinder and lifting piston, and a pump unit, with pump cylinder and pump piston. The pump piston is actuated by a pump lever and works against the action of a spring, while the pump cylinder is connected to the lifting cylinder by a hydraulic line. A valve is positioned in the hydraulic channel that lies between the pump chamber of the pump cylinder and the lifting cylinder; the valve opens when the pump piston is actuated, with the result that the hydraulic medium flows to the lifting cylinder compartment.

The known hydraulic device has a second valve, which makes possible a secondary flow of hydraulic medium into the pump chamber inside the pump cylinder, underneath the pump piston.

The known hydraulic device consists of a housing in which a hydraulic cylinder and a tank chamber are provided. Screwed into a base plate in the housing is a pump cylinder, whose free end terminates in the tank chamber.

In other known devices not only the pump cylinder but also the hydraulic cylinder is screwed into a base plate.

Although this known hydraulic device has proven itself in actual practice, it is desirable to introduce changes that ensure a more cost-effective manufacture while, at the least, maintaining the present functional capability.

This problem is solved by the features of patent claim 1.

Further elaborations of the invention are described in the secondary claims.

The basic concept of the invention is to reduce the number of individual parts and to thereby permit a more cost-effective manufacture. The invention achieves this in that the side walls of the lifting cylinder, the side walls of the pump cylinder, and the side walls of at least one tank chamber are each formed by a compartment belonging to a profile tube. The profile tube will ideally consist of aluminum and will advantageously take the form of an economical extrusion profile.

A special advantage emerges when, along with the lifting cylinder, the pump cylinder, and the tank chambers, the tension rod compartments that accommodate the tension rod screws and that are needed to secure a lid and a base are also an integral part of the profile tube and thereby contribute simultaneously to stabilizing the entire profile tube. The tension rod compartments assist in guiding the screws and facilitate the installation of the connecting screws into the threaded holes provided in the base part.

An embodiment that is especially stable and that is not sensitive to unintended deformation during operation results when the chamber for the lifting cylinder is centrally positioned in the profile tube and the other compartments are positioned between the profile tube wall and the lifting cylinder chamber. This advantageously ensures that adjacent compartments are connected by the compartment walls or additional connecting walls. A particularly stable form is provided by an embodiment in which the two tension rod compartments, the pump cylinder compartments, and an additional reserve compartment are positioned at 90° intervals around the central lifting cylinder compartment.

The compartments formed between the tension rods and the reserve compartment, as well as the pump cylinder compartments, serve as tank chambers, which are connected and which communicate with each other other, ideally by way of grooves. Connecting holes should be provided in the upper and lower portion of the tank compartments in order to permit not only an exchange of hydraulic medium but also of air in the upper portion.

It is also of special advantage if both return valve holes are positioned coaxially, a feature which considerably simplifies the design of the valve units. The two valve holes are separated one from the other by an inserted part within the pump cylinder, such that the inserted part can be screwed into a base plate attached to the profile tube, thereby simultaneously positioning the profile tube on the base plate. The opposing part is assumed by a guide component that is provided in the pump cylinder opposite the inserted part and that can be screwed into the lid; among other things, this guide part has the task of axially guiding the pump tappet and of receiving the seal.

A special advantage is provided when the inserted part of the hydraulic device according to the invention is produced from prefabricated multi-cornered material, ideally material that is hexagonal in shape. This provides a secure cylindrical-coaxial attachment between the profile tube and the base part; in addition, it allows flow channels to form through the remaining open areas. These flow channels, in interaction with the flexible valve plate which is positioned above them and which acts as a suction valve, permit the secondary suction of the hydraulic medium into the pump cylinder compartment.

It has proven to be advantageous to provide an easily detectable pressure point on the pump lever at the end of the pump upward stroke and before the beginning of the falling stroke. To this end, there is positioned at the upper end of the pump tappet a clearly dimensioned open spring steel ring, together with a partially conical sleeve. Upon actuation of the pump lever and before the falling stroke begins, the spring steel ring in the conical part of the sleeve comes into position and, upon intentional further actuation of the pump level, exerts a high axial force on the pump tappet, specifically by pressing into the cone and creating a high degree of radial deformation, plus friction. This strong surge of force signals to the person operating the pump that a falling motion is being introduced and thereby induces an increased alertness in the operator when the pump lever is actuated, thereby preventing a brief, unintentional fall. The elastic ring lying coaxial to the spring steel ring serves both to center the spring steel ring and to reinforce the spring force.

The invention is next described in greater detail on the basis of an exemplary embodiment and six figures.

Shown are:

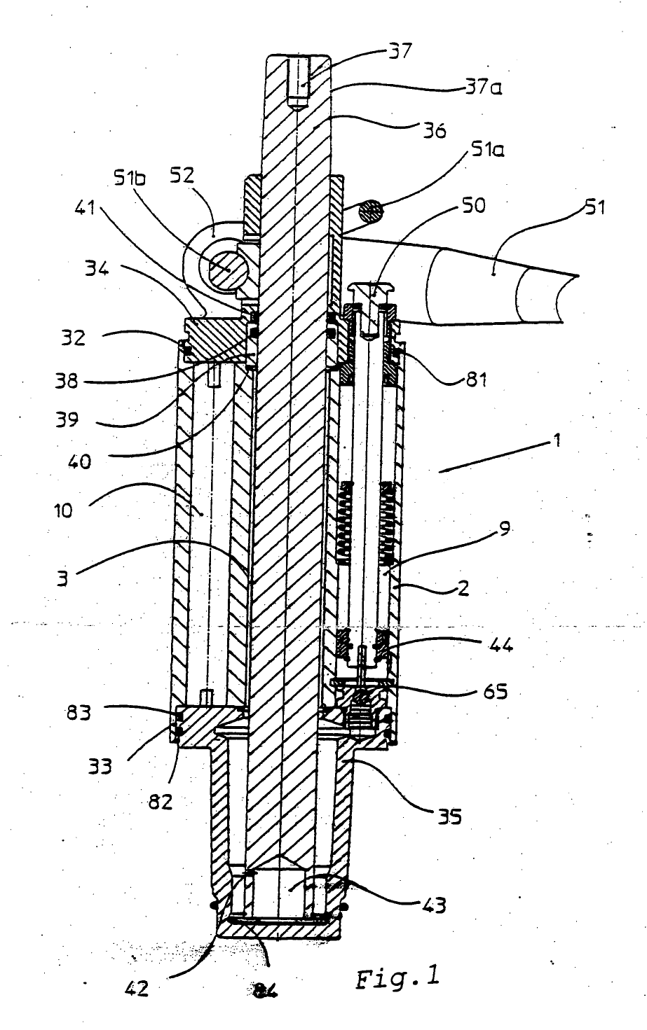

FIG. 1 an axial section through the hydraulic device according to the invention

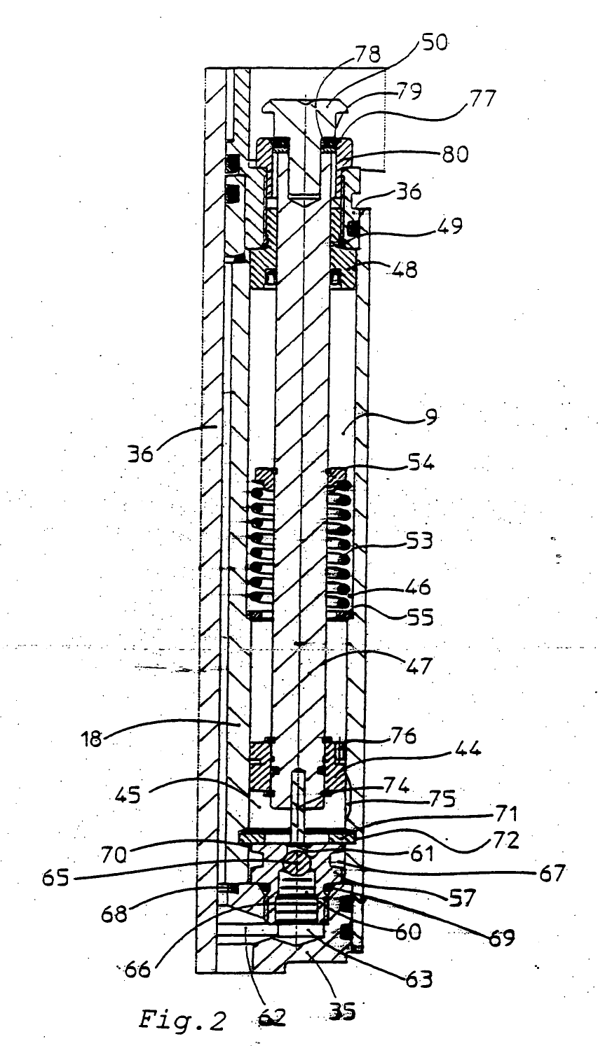

FIG. 2 a detailed section of the pump cylinder, with fixtures in accordance with FIG. 1

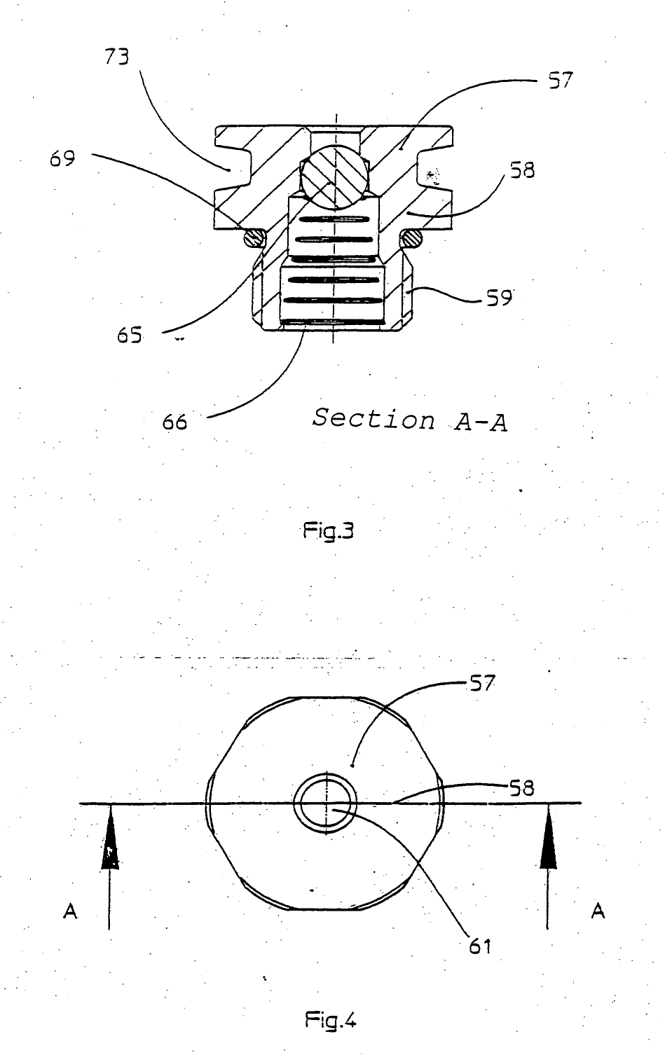

FIG. 3 an axial section through an inserted part

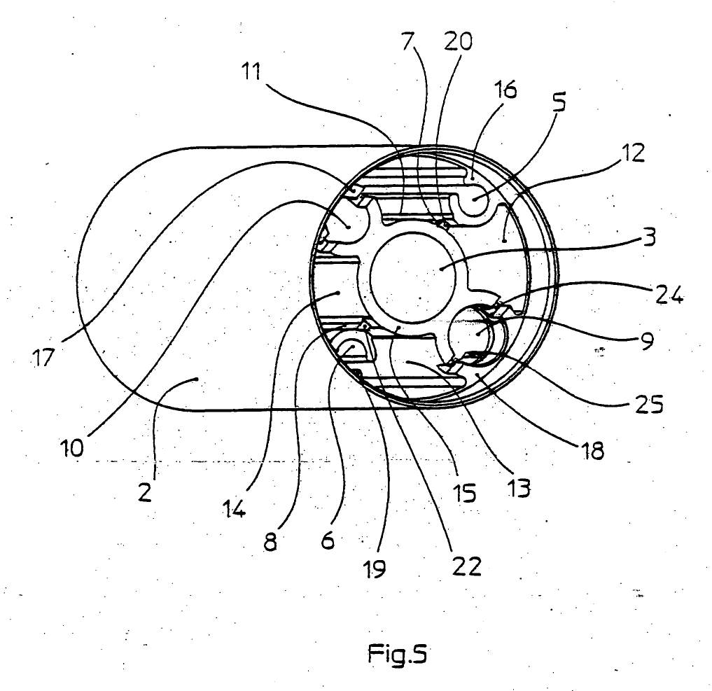

FIG. 4 a top view of an inserted part

FIG. 5 a perspective view of a profile tube

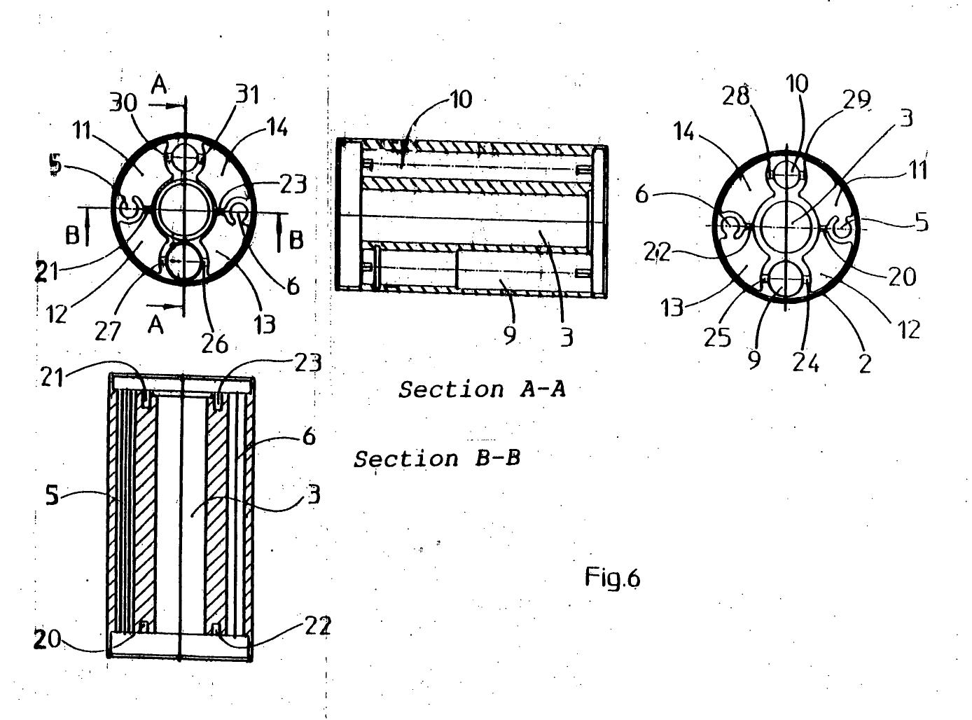

FIG. 6 the profile tube shown in different sections

The hydraulic device 1 shown in FIG. 1 is intended for and suitable as a pedal-operated guidance and height-adjusting system, e.g. for a chair, table, pallet, or deposit station.

The hydraulic device basically consists of an extruded aluminum profile tube 2 with a number of compartments. A lifting cylinder compartment 3 is provided in the center of the profile tube 2. Between the lifting cylinder compartment 3 and a profile tube wall 4 are two diametrically positioned tension rod compartments 5, 6, which are directly connected to the profile tube wall; they are also connected to the lifting cylinder compartment 3 by way of connecting walls 7, 8. Offset 90° thereto and also diametrically positioned are a pump cylinder compartment 9 and a reserve compartment 10. In addition, four tank compartments 11, 12, 13, 14 run through the profile tube.

The tank compartment 11 is bordered by the lifting cylinder wall 15, the wall 16, the tension rod compartment 5, the profile tube wall 4, and the wall 17 of the reserve compartment 10. The wall 16 of the tension rod compartment 5 exhibits a longitudinal hole running through to the tank compartment 11.

The tank compartment 12 is positioned next to the tank compartment 11 and is bordered by the lifting cylinder wall 15, the wall of the pump cylinder compartment 18, the profile tube wall 4, and the wall 16 of the tension rod compartment 5.

The tank compartment 13 is positioned diametrically opposite the tank compartment 11 and is bordered laterally by the lifting cylinder wall 15, the wall 18, the pump cylinder compartment 9, the profile tube wall 4, and the wall 19 of the tension rod compartment 6. The wall 19 of the tension rod compartment 6 exhibits a slot-shaped longitudinal hole that runs to the tank compartment 13.

The tank compartment 14 is bordered by the profile wall 4, the lifting cylinder wall 15, the wall 17, the reserve compartment 10, and the wall 19 of the tension rod compartment 6.

In their lower portions the tank compartments 11, 12 are connected in communicating fashion by a groove 20. In the upper area of the profile tube 2 the compartments 11, 12 are connected in communicating fashion by a groove 21. An exchange of hydraulic medium takes place through the groove 20, and an exchange of air takes place through the groove 21. In analogous fashion, the tank compartments 13, 14 are connected in communicating fashion by grooves 22, 23. The grooves 20, 21, 22, 23 are applied to the connecting walls 7, 8 which connect the tension rod compartments 5, 6 and the lifting cylinder compartment 3.

The tank compartments 12, 13 and 11, 14 are also connected in communicating fashion. To this end, two diametrically opposite grooves 24, 25 are provided in the lower area of the wall of the pump cylinder compartment 9. Once again, there are comparable grooves 26, 27 in the upper area of the wall 18 of the pump cylinder compartment 9. Unlike the grooves 20 to 23 and 28 to 31, which have only a connecting function, the grooves 24, 25 joining the pump cylinder compartment and the compartments 12, 13 are required as suction channels for hydraulic medium to the double valve. In analogous fashion, the grooves 26, 27 are needed for flow-off of the hydraulic medium from the pump cylinder compartment into the neighboring compartments 12, 13.

Grooves 28, 29, 30, 31 are furnished in the upper and lower areas of the wall 17 of the reserve compartment 10. It is naturally possible to use only one tank compartment as a reserve container for the hydraulic medium. In this case a communicating connection between the tank compartments is not necessary.

All compartments up to and including tank compartments 11, 12, 13, 14 have an inner cross-section that is circular in shape.

Applied to the upper and lower ends of the profile tube 2 are circumferential shoulders 32, 33, into which a cylindrical lid 34, or a base part 35, can be inserted. The lid 34 is sealed against the circumferential part 32 by means of an annular seal. Two axially spaced annular seals 82, 83 are provided to seal the base part.

A lifting piston, which moves axially, is positioned in the lifting cylinder compartment 3. The load to be lifted, e.g., the seat of a barber chair, is attached to the upper end of the lifting piston 36, on the outer cone 37a, and is secured with a screw in the inner thread 37, which for the sake of simplicity is not depicted. By means of a sealing ring 38 the lifting piston 36 is sealed against a guide sleeve 39 inserted in the lid 34. The guide sleeve 39 is sealed against the lifting piston compartment 3 by means of an annular seal 40. The lifting piston 36 is sealed against the lid 34 with an annular seal 41 located above the sealing ring 38. A connecting channel (not depicted) to a tank compartment is provided between the seals 38, 40. When the lifting piston 36 is located in its uppermost position a radial channel 42 in the lifting piston creates a connection between the tank compartments, the undepicted connecting channel between the seals 38, 40, and the lifting cylinder compartment 3 filled with hydraulic medium, by means of a pocket hole 43 in the lower face of the lifting piston 36. Thus in this uppermost position of the lifting piston 36 it is possible for the hydraulic medium to escape into a tank compartment by passing through the pocket hole 43, the channel 42, and the undepicted connecting channel. This connection is necessary, since in the absence of a connecting channel the back pressure would make it impossible for the lifting piston 36 to execute a falling stroke when occupying its uppermost position. Furthermore, the connection to the tank compartment serves to remove air from the pump system when, e.g., air has penetrated due to an uneven positioning of the hydraulic device.

In the depicted exemplary embodiment the entire lifting cylinder compartment 3 formed by the profile tube 2 is designed as a lifting cylinder pressure chamber. An elastic ring 84 is provided beneath the piston base 3 for a soft cushioning of the impact when the piston falls.

The pump cylinder compartment 9 is divided into a pump chamber 45 and a pump tappet chamber 46 by a pump piston 44 that is sealed off from the wall 18 of the pump cylinder compartment 9. A pump tappet 47 projects from the pump piston 44 through the pump tappet chamber 46. The pump tappet compartment 46 is bordered on its upper end by a guide sleeve 48, which is screwed into the lid 36 and is sealed off from the lid 36 by means of a sealing ring 49. The pump tappet 47 extends above the lid 36 with a thrust member 50, and there is a pump bow 51a that acts on this thrust member 50 and thus on the pump tappet 47 and the pump piston 44. This pump bow 51a is connected to the pump lever 51 by an eccentric shaft 51b and is articulated to a bearing eye 52 belonging to the lid. Thus when the pump lever 51 is pressed down the pump tappet 47 moves axially and downwards. In order to return the pump piston 44 and its pump tappet 47 to its former position, a coil spring 53 is provided which is supported on one side by a circumferential ring 54 on the pump tappet 47 and on the other side by an annular disk 55, which is attached to an annular collar 56 in the circumferential wall 18 of the pump cylinder compartment 9. The annular collar 56 is produced by boring the extruded profile from the top. As a result the upper part of the pump cylinder compartment 9 has a larger diameter than the lower part of the pump cylinder compartment 9.

Screwed into the base part 35 is an inserted part 57, whose outer contour is formed by an upper hexagonal part 58 that has been rounded off and that has a circular groove 73, and by a lower threaded part 59 and an interposed recess for a sealing ring 69.

The profile tube 2 is centered on the base part 35 with the aid of the hexagonal section 58. It is centered on the lid by means of the guide sleeve 48.

The inserted part 57 is hollow in design. The central, basically cylindrical cavity 60 formed inside the inserted part is connected to the pressure chamber 45 above by means of a through-hole 61 which can be sealed. A connecting channel 62 to the lifting cylinder compartment 3 is provided in the lower portion of the cavity 60. One component of the connecting channel 62 is a pocket hole 63 in the base part 35. This hole 63 is connected to a trapezoidal recess in that portion of the lifting cylinder compartment that extends into the base part 35.

Provided inside the cavity 60 is a valve piston 65 designed as a ball valve. This valve piston 65 closes the through-hole 61 due to the spring force of the spring 66.

A basically ring-shaped supply chamber 67 is formed between the inserted part 57 and the pump cylinder compartment wall 18. The supply chamber 67 is positioned in concentric fashion relative to the through-hole 61 and the cavity 60. The supply chamber 67 communicates with the tank compartment 12, 13 through the grooves 24, 25. Toward the bottom the supply chamber 67 is bordered by the base part 35. The supply chamber 67 is sealed off from the lifting cylinder compartment 3 by the sealing rings 68, 69.

An annular gap 70 is formed in the upper portion of the supply compartment 67 between the inserted part 57 and the wall 18. The annular gap 70 represents a valve opening between the pump chamber 45 and the supply chamber 67. The annular gap 70 is overhung on all sides by a flat valve element designed as an annular part 71. The annular part 71 is manufactured from an elastic material, ideally polyurethane. The annular part 71 must be elastic and sufficiently stable both to seal the annular gap 71 and to withstand the pressure forces exerted on it.

The annular part 71 is movably mounted in a circumferential groove 72, such that the circumferential groove 72 is wider than the annular part 71. The annular part 71 rests in sealing fashion in the circumferential groove 72, on one side, and on the surface of the inserted part 57, on the other side. If the pump piston is moved upwards, a negative pressure arises in the pump chamber 45, by means of which the annular part 71 is moved upwards in the axial direction, whereby a connection between the pump chamber 45 and the tank compartments 11, 12, 13, 14 is created, with the result that hydraulic medium can flow into the pump chamber 45 via the grooves 24, 25, the supply chamber 67, the annular gap 71, and the gap between the annular part 71 and the inserted part 57. On the other hand, if the pump piston 44 is moved axially in the downwards direction, the annular part 71 is pressed in sealing fashion onto the groove wall and the surface of the inserted part 57. In the ideal case, the lower portion of the groove's side wall will rest on precisely the same plane as the surface of the inserted part 57.

The flow of the hydraulic medium into the pump chamber 45 via the supply chamber 67 is facilitated by the fact that the inserted part 57 is multi-angular in shape. This creates connections between the grooves 24, 25 and the pump chamber 45 that have a large, open cross-section. A distribution of the hydraulic medium within the supply chamber 67 is ensured by a circumferential groove 73 in the inserted part 57.

An actuating pin 74 is provided on the lower side of the pump tappet 47. This actuating pin 74 works against the force of spring 66 and presses the valve piston 65 downwards after overcoming a pressure point, so that the through-hole 61 is opened. The lifting piston 36 then falls and forces hydraulic medium through the connecting channel 62 and the cavity 60, and through the open through-hole 61, into the pump chamber 45. Proceeding from that point the hydraulic medium reaches the pump tappet chamber 46 through an indentation acting as a choke 75 that is provided in the wall 18 and through a channel 76 within the pump piston 44; and from there into the tank compartments 12, 13 via the grooves 26, 27.

The scope of the invention allows for the channel 76 in the pump piston 44 to be omitted and for the indentation acting as a choke 75 to be lengthened. This would be an advantage, inasmuch the introduction of the channel 76 in the pump piston 44 would be uncalled for.

The pressure point that is overcome so that the actuating pin 74 can displace the valve piston 65 is basically produced by the spring steel ring 79 that is positioned below the thrust member 50 as said ring 79 presses into the cone. The operator will perceive this moment by the need for an increase in force.

The described hydraulic device 1 operates in the following manner. To actuate the hydraulic device 1 the pump lever 51 must be moved downwards, that is, against the operative direction of the spring force exerted by the coil spring 53. As a result, the pump piston 44 will be moved downwards. Under the action of the coil spring 53, the piston 44, and the pump lever 51 along with it, will be returned to their starting position. During this intake stroke the annular part 71 is lifted and opens the annular gap 70. The hydraulic medium located in the tank compartments 11, 12, 13, 14 is sucked into the pump chamber 45 inside the pump cylinder compartment 9 after passing through the grooves 25, 26, the supply chamber 67, and, finally, the annular gap 70. In the next pump stroke the annular part 71 closes the annular gap. The hydraulic medium that is held under pressure in the pressure chamber works against the action of the coil spring 66 and opens the ball valve with the valve ball 65, with the result that the hydraulic medium passes through the axially extending through-hole 61 and the cavity 16 inside the inserted part 57 and reaches the lifting cylinder compartment 3, to lift the piston 36. When the pump stroke is complete, the valve piston 65, operating under the action of the coil spring 66, closes the through-hole 61, so that the pressure chamber 45 remains closed until the next pump stroke, or until the falling action described below.

The pump action can be repeated until the piston 36 reaches its uppermost position. As soon as the hole 42 of the piston 36 has reached a connection (not depicted), which in the plane of projection protrudes between the seals 38 and 41 and which leads to a tank compartment, the hydraulic medium flows back through this connection into the tank compartments. Renewed lifting of the piston 36 is thus prevented.

If the falling process must be deliberately introduced, the clearly identifiable pressure point must be overcome at the moment when the spring steel ring 79 that follows the pump tappet 47 from above comes up against the cone part 77 of the sleeve 80, in order to again move the pump tappet 57 in the downwards direction.

To lower the lifting piston 36 the pump lever 51 and the pump bow 51a must be moved into their lowest position, i.e., until the thrust member 50 abuts against the sleeve 80. In this position the actuating pin 74 comes up against the valve ball 65. This valve ball 65 releases the through-hole 61, with the result that hydraulic medium from the lifting cylinder compartment 3 reaches the pressure chamber 45 and passes into the pump tappet chamber 46 via the choke indentation 75, to move from there into the tank compartments 12, 13.

List of Reference Numerals
1 hydraulic device
2 profile tube
3 lifting cylinder compartment
4 profile tube wall
5 tension rod compartment
6 tension rod compartment
7 connecting wall
8 connecting wall
9 pump cylinder compartment
10 reserve compartment
11, 12, 13, 14 tank compartments
15 lifting cylinder wall
16 wall
17 wall
18 wall
19 wall
20 groove
21 groove
22 groove
23 groove
24 groove
25 groove
26 groove
27 groove
28 groove
29 groove
30 groove
31 groove
32 circumferential shoulder (upper)
33 circumferential shoulder (lower)
34 lid
35 base part
36 lifting piston
37 threaded hole
37a outer cone
38 sealing ring
39 guide sleeve
40 annular seal
41 annular seal
42 channel
43 pocket hole
44 pump piston
45 pressure chamber
46 pump tappet chamber
47 pump tappet
48 guide sleeve
49 sealing ring
50 thrust member
51 pump lever
51 a pump bow
51 b eccentric shaft
52 bearing eye
53 coil spring
54 circumferential ring
55 annular disk
56 annular collar
57 inserted part
58 hexagonal section
59 threaded section
60 cavity
61 through-hole
62 connecting channel
63 pocket hole
[sic]
65 valve piston (valve ball)
66 spring
67 supply chamber
68 sealing ring
69 sealing
70 annular gap
71 annular part (valve element)
72 circumferential groove
73 circumferential groove
74 actuating pin
75 choke indentation
76 channel
77 cone
78 plastic ring
79 spring steel ring
80 sleeve
81 sealing ring
82 sealing ring
83 sealing ring
84 ring

1. Hydraulic device with a lifting piston contained in a lifting cylinder, a pump piston that moves within a pump cylinder, a tank chamber for a hydraulic medium, and two valve units
wherein
the lifting cylinder (3), the pump cylinder (9), and the tank chamber (11, 12, 13, 14) are each formed by at least one compartment (3, 9, 11, 12, 13, 14) belonging to a profile tube (2).

2. Hydraulic device according to claim 1,
wherein
the profile tube (2) is an extruded profile, ideally of aluminum.

3. Hydraulic device according to one of the preceding claims claim 1, wherein
at least one and ideally two tension rod compartments (5, 6) are provided in the profile tube (2).

4. Hydraulic device according to one of the preceding claims claim 1 wherein a reserve compartment (10) is provided in the profile tube (2).

5. Hydraulic device according to one of the preceding claims claim
wherein
the lifting cylinder compartment (3) is positioned in the center of the profile tube (2).

6. Hydraulic device according to claim 5, wherein
the two tension rod compartments (5, 6), the pump cylinder compartment (9), and the reserve compartment (10) are positioned between the lifting cylinder compartment (3) and the profile tube wall (15), and are ideally offset by 90° one to the other.

7. Hydraulic device according to claim 6,
wherein
the tension rod compartments (5, 6), the pump cylinder compartment (9), and the reserve compartment (10) are each connected to the profile wall (4) and to the lifting cylinder compartment (3), and thereby form four tank compartments (11, 12, 13, 14).

8. Hydraulic device according to claim 7,
wherein
at least two adjacent tank compartments (11, 12) (12, 13) (13, 14) (14, 11), and ideally all adjacent tank compartments, are connected in communicating fashion.

9. Hydraulic device according to claim 7,
wherein
the tension rod compartments (5, 6) are open to at least one of the adjacent tank compartments (11, 13).

10. Hydraulic device according to claim 1, wherein
the entire hydraulic compartment (3) is designed as a pressure chamber.

11. Hydraulic device according to claim 1, wherein
a pump piston (44) divides the pump cylinder compartment (9) into a pressure chamber (45) and a pump tappet chamber (46).

12. Hydraulic device according to claim 11,
wherein
a connecting hole (26, 27) leading to a tank compartment (12, 13) is provided in the upper portion of the pump tappet chamber (46).

13. Hydraulic device according to claim 11,
wherein
a supply chamber (67) that connects in communicating fashion with at least one tank compartment (12, 13) is provided adjacent to the pressure chamber (34), ideally beneath the pressure chamber (45), while a valve hole (70), which ideally is axially aligned and can be closed with a valve element (71), is provided between the pressure chamber (45) and the supply chamber (67).

14. Hydraulic device according to claim 13,
wherein
the supply chamber (67) is bordered in the radial direction, at least in part, by the inner wall of the pump cylinder compartment, on one side, and
on the other side, at least in part, by the circumferential wall of an inserted part (57) positioned at least in part inside the pump cylinder compartment (9).

15. Hydraulic device according to claim 13,
wherein
the inserted part (57) is designed as a multi-cornered part, ideally a stripped hexagon.

16. Hydraulic device according to claim 13,
wherein
a circumferential groove is applied to the inserted part (57).

17. Hydraulic device according to claim 14,
wherein
the valve hole (70) between the supply chamber and the pressure chamber is formed by a gap that runs in the axial direction and whose outer contour is ideally round and whose inner contour is ideally multi-cornered, said gap being located between the inserted part and the inner wall of the pump cylinder compartment.

18. Hydraulic device according to claim 17,
wherein
the valve element (71) is designed as an annular part, that ideally is flat and elastic.

19. Hydraulic device according to claim 17,
wherein
the valve element (71) is mounted so as to permit axial movement, ideally in a circumferential groove (72) in the pump cylinder wall, and projects upward from the annular gap (70) that exists between the inserted part (57) and the inner wall of the pump cylinder compartment, and seals the annular gap (70) when pressure is applied to the pressure chamber (45), and in the process will ideally rest in sealing fashion against the lower annular surface of the groove (72), on the one hand, and on the other, against the surface of the inserted part (57).

20. Hydraulic device according to claim 14,
wherein
the inserted part (57) is screwed into the base part (35).

21. Hydraulic device according to claim 14,
wherein
the inserted part (57) is provided with a cavity (60) ideally located in the center of the inserted part (57) and exhibiting a through-hole (61) that can be closed and that leads to the pressure chamber (45), while a channel for the hydraulic medium is provided between the through-hole (61) and the hydraulic cylinder compartment.

22. Hydraulic device according to claim 20,
wherein
the through-hole (61) is closed by means of a valve piston (65) that is positioned inside the cavity (60) and that is ideally designed as a spring-loaded ball.

23. Hydraulic device according to claim 22,
wherein
the valve piston (65) is moved by means of an actuating pin (74) opposite the direction of a spring force, to permit the flow of hydraulic medium through the through-hole (61).

24. Hydraulic device according to claim 22,
wherein
the actuating pin (74) is positioned coaxially on the underside of the pump tappet, ideally at a precisely adjusted length.

25. Hydraulic device according to claim 1, wherein
at least one indentation (75) acting as a choke is provided in the wall of the pump cylinder compartment, such that said choke indentation (75) forms a channel for the flow of hydraulic medium from the pressure chamber (45) into the pump tappet chamber (46) when the pump piston (44) is in the appropriate axial position within the pump cylinder compartment (9).

26. Hydraulic device according to claim 1, wherein
a channel (76) for hydraulic medium is provided within the pump piston (44), which channel (76), together with a choke indentation (75) within the wall of the pump cylinder compartment, forms a channel for the flow of hydraulic medium from the pressure chamber (45) into the pump tappet chamber (46).
